(19) United States
(12) Patent Application Publication
(10) Pub. No.: US 2008/0134907 A1
(43) Pub. Date: Jun. 12, 2008

(54) Recirculated, cooled, airflow system for a roaster

(76) Inventor: Sadamu Iiyama, Los Angeles, CA (US)

Correspondence Address: PATENT LAW & VENTURE GROUP, 2424 S.E. BRISTOL, SUITE 300, NEWPORT BEACH, CA, 92660, US

(21) Appl. No.: 12/001,379

(22) Filed: Dec. 10, 2007

Related U.S. Application Data
(60) Provisional application No. 60/874,317, filed on Dec. 11, 2006.

(51) Int. Cl. A01J 99/00

(52) U.S. Cl. 99/467

(57) ABSTRACT

A coffee bean roaster having a recirculated, filtered exhaust airflow; the coffee bean roaster including a filter system with a plurality of screens wherein a fluid source is sized and configured to distribute fluid across the screens so as to maintain wetness on their surfaces. The screens are positioned between a filter airflow inlet and a filter airflow outlet for passage of airflow through the screens from a filter airflow inlet to the filter airflow a. The screens have an upper end and a lower end, the fluid source sized and configured to dispense fluid from the upper ends, as a drip system, for distributing fluid throughout the screens toward the lower ends. A distribution hose is provided in fluid communication with the fluid source for distributing fluid to the screens.

### RELATED APPLICATIONS

This application claims the filing date Dec. 11, 2006 of provisional application 60/874,317.

### BACKGROUND OF THE INVENTION

1. Field of the Invention

This invention relates generally to cooling and filtering systems for use with coffee bean roasters and to a coffee bean roaster facilitated with such a system.

2. Description of Related Art

The following art defines the present state of this field and each disclosure is hereby incorporated herein by reference:

Crutcher, Jr., U.S. Pat. No. 2,762,289, discloses a design for a coffee roasting apparatus.

Gladu, U.S. Pat. No. 3,660,045, discloses water sprays projected in the form of a curtain through smoke rising through a smokestack transversely of the direction of smoke movement entrain particulate material in the smoke and carry it away. The sprays may cooperate with a baffle which aids precipitation of particles and creates turbulence to facilitate such separation further. Additionally, combustible impurities may be burned by flame jets preceding the spray washing operation, and supplemental air may be mixed with the smoke preceding the flame zone.

Moore, III, U.S. Pat. No. 4,271,603, discloses a personal coffee roaster for effecting roasting of small quantities of green coffee beans and having limited physical size and weight, that has a roasting chamber with at least one perforate wall, elements for creating a heated gaseous flow through the perforate wall into the roasting chamber and an exit orifice leading from the roasting chamber, in gaseous communication therewith, for providing an outlet for the heated gas flow. The apparatus further has an air flow rate controlling element for variably controlling the rate of flow of the heated gas through the roasting chamber. The roasting chamber, stirring elements therein, and a driven rotating shaft are inclined to a vertical axis for effecting better tumbling action and stirring within the roasting chamber.

Kumagai et al., U.S. Pat. No. 4,325,191, discloses a coffee roaster in which roasting is automatically terminated by the provision in the roaster of a temperature sensing device which detects the temperature of the coffee beans during the steps of stirring and roasting and produces at a predetermined appropriate temperature a signal which is used to terminate the roasting.

Elevitch, U.S. Pat. No. 4,425,720, discloses a coffee roaster, preferably having no moving parts and suitable for domestic use, in which a current of hot air is caused to pass through a layer of coffee beans supported on a perforated plate or belt, the space above the beans being enclosed by sidewalls and a top cover having one or more openings for outflow of air. The top cover causes heat to be radiated back onto the beans and the flow of hot air causes water vapor and other gases resulting from roasting, also smoke, to be rapidly removed from the beans and vented. In a variant the roaster may be enclosed in an oven and the cover of the oven may be imperforate, the oven being provided with means to vent air, water vapor and other gases.

Murray, U.S. Pat. No. 4,484,064, discloses a coffee roaster suitable for use in the home and/or retail establishments that includes a container where initially green unroasted coffee beans are levitated while heated air is forced through the beans to roast the beans to a desired degree. The container is shaped to allow continuous rotation of the beans to avoid charring and uneven roasting. The warm air is circulated in a closed circulation loop and, after roasting is completed, cool ambient air is circulated through the beans to cool them. An optional companion grinder is provided to grind the fresh roasted beans for immediate coffee brewing.

Gell, Jr., U.S. Pat. No. 4,494,314, discloses a coffee roaster which roasts coffee beans in an oven chamber that employs both radiant and convection heating techniques while the beans are continually intermixed in a fluidized bed. Roaster control means are provided to terminate the roasting process by quenching the beans and oven chamber while maintaining the beans in a fluidized bed to avoid scorching or further roasting by the residual heat of the coffee bean mass.

Cox et al., U.S. Pat. No. 4,844,721, discloses an aqueous liquid containing unsaturated vegetable, marine or land animal oil or liquid fat, preferably drying or semidrying oil, that is used as a scrubbing liquid to remove pollutant from an air stream. Specifically, styrene constituting an air pollutant is absorbed from the air and polymerized to polystyrene by ultraviolet light radiation to facilitate its separation from the scrubbing liquid.

Tamaki et al., U.S. Pat. No. 4,860,461, discloses a roasting body that is composed of a roasting body, a rotary drum supported on the inside of the roasting body to rotate in a horizontal attitude to accommodate and stir the coffee beans, infrared heaters disposed on the inner wall surface of the roasting body to surround the rotary drum in order to heat the coffee beans accommodated in the rotary drum by radiant heat, and a circulating path to circulate the hot air in the rotary drum into the roasting body in order to utilize the thermal energy effectively.

Igusa et al., U.S. Pat. No. 4,871,901, discloses a coffee roasting apparatus that comprises a cylindrical container, a cylindrical drum rotatably extended within the center portion of the container, and a heater element deposed within the drum. The apparatus includes a blower device to cause air circulation within the interior of the container to more uniformly heat the beans. The heater element is controlled by a control device to reduce the calorific value of the heater element when the temperature of the container reaches a predetermined temperature. Therefore, abnormal temperature in the container is prevented, while the roasting operation is speedily done. A control device for the blower device is also disclosed which will vary the speed of the blower in response to changes in the input voltage. In this way, an increase in the input voltage which may have caused unwanted overheating is avoided by a corresponding increase in air circulation.

Waligorski, U.S. Pat. No. 5,269,072, discloses an improved coffee roaster for roasting a selected volume of coffee beans in a relatively quick and efficient manner. A roasting cavity is provided for receiving and roasting a selected volume of green coffee beans. A timer is provided for controlling the roasting time. A heating coil is provided for generating heat to roast the coffee beans. A motor drives a fan, which forces air through the heating coil and toward the roasting cavity. Slots defined by the roasting cavity direct the heated air into the roasting cavity such that the coffee beans are agitated and roasted. Chaff is evacuated with the air through the opening in the top of the roasting cavity. A chaff collector is provided for collecting the chaff evacuated while allowing the escape of air.

Dinh, U.S. Pat. No. 5,343,632, discloses a dryer that is designed as a closed system in which heated air used to dry the materials is continuously recycled within the drying compartment of the dryer without being discharged to the atmosphere, thus increasing the efficiency of the system while preventing the discharge of contaminated vapors to the atmosphere and also conserving energy which would otherwise be required to heat or air-condition the air drawn into the dryer from the building in which the dryer is located. A regenerative heat exchanger and an atmospheric cooler/condenser are provided in the dryer and condense and remove moisture from the saturated air and transfer the heat of condensation back into the air before the air is reheated and recycled back to the materials to be dried. The drying compartment may comprise an enclosed tunnel through which a rack of superposed trays are conveyed or may comprise some other conveying mechanism.

Song, U.S. Pat. No. 5,564,331, discloses an apparatus for roasting raw coffee beans that can instantly roast a small quantity of raw coffee beans according to personal taste and provide a unique taste and fragrance of coffee, and in particular to an apparatus suitable for home use. The apparatus has a roasting vessel for containing raw coffee beans to be roasted. A plurality of air openings are provided for creating a whirling vertical motion to a heated air stream ascending therethrough, whereby the raw beans are roasted and also caused to have their hulls separated and caused to ascend upwardly with the air stream to a hull-receiving vessel.

Newman, U.S. Pat. No. 5,609,097, discloses a coffee bean roaster with a cylindrically shaped transparent viewing tower in which coffee beans are roasted by an upwardly directed hot gaseous stream while being fluidized into a visually pleasing ascending central and descending outside columns during the roasting cycle. A two way valve located at the bottom of the tower permits the gaseous stream to enter the tower when the valve is in a first position and the roasted beans to be diverted to a cooling chamber when the valve is in a second position.

Lemme et al., U.S. Pat. No. 5,638,607, discloses a roasting apparatus for coffee beans and other food that includes a removable drum on the housing rotatable about a horizontal axis and drive means on the housing for supporting and rotating the drum. The drum has a plurality of internal vanes arranged such that i) as the drum is rotated in one direction the beans are stirred and retained by the vanes within the drum, and ii) as the drum is rotated in the opposite direction the beans are moved by the vanes toward the drum opening for dispensing from the roasting apparatus. A removable cover includes a safety interlock which, when activated, prevents opening of the cover when the drum is at bean roasting temperature and which automatically deactivates upon cooling of the drum to permit opening of the cover to remove the drum. A chaff collector has an opening for alignment with the drum opening and a lip which is captured by the cover when the cover is in the closed position, and is non-removable from the roasting apparatus housing when the cover is in the closed position. The chaff collector includes a baffle for deflecting chaff into the chaff collection portion while permitting dispensing of the beans out of the roasting apparatus.

The prior art described above teaches bean roasting equipment of various types, but fails to teach such equipment having fume scrubbing devices of the type described and claimed in this specification.

### SUMMARY OF THE INVENTION

The present invention teaches certain benefits in construction and use which give rise to the objectives described below.

In a preferred embodiment of the present invention, there is provided a coffee bean roaster with chilled, recirculated, filtered exhaust airflow. The coffee bean roaster includes a roasting drum sized and configured to receive coffee beans for roasting therein. The roasting drum has a drum airflow inlet and a drum airflow outlet for exhausting airflow from the roasting drum. The coffee bean roaster further includes a blower configured to blow airflow through the drum airflow inlet for venting the roasting drum. The coffee bean roaster includes a fluid filter having a filter airflow inlet and a filter airflow outlet. The filter airflow inlet is in fluid communication with the drum airflow outlet. The fluid filter is configured to filter airflow from the roasting drum. The filter airflow outlet is in fluid communication with the blower for recirculating airflow into the roasting drum.

A primary objective of the present invention is to provide an apparatus and method of use of such apparatus that yields advantages not taught by the prior art.

Another objective of the invention is to enable fast cool-down of roasted beans in a roaster.

A further objective of the invention is to enable entrainment of smoke given off from the roasted beans.

A still further objective of the invention is to recycle chilled air flow over the roasted beans so that installation of an exhaust stack is not necessary.

A yet further objective of the invention is to enable chilling of a cooling air flow without mechanical refrigeration.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawing illustrates a best mode embodiment of the present invention. In such drawing:

FIG. 1 is a symbolic diagram illustrating a coffee bean roaster with a forced air recycling, filtering and chilling system according to the present invention.

### DETAILED DESCRIPTION OF THE INVENTION

The above described drawing figures illustrate the present invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

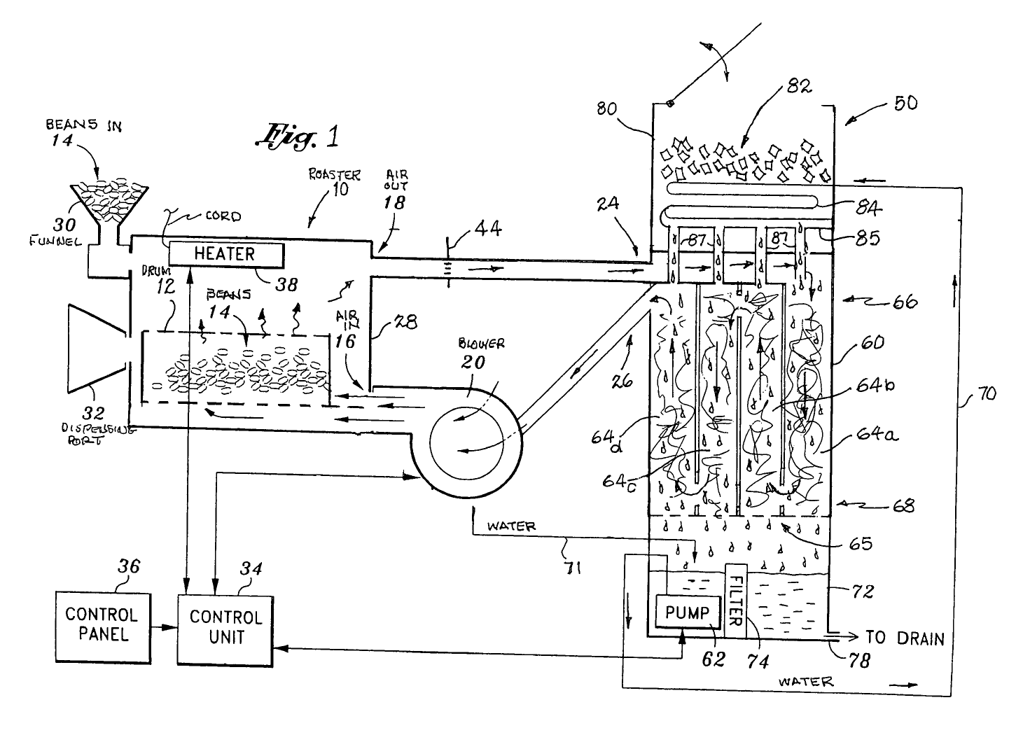

In an embodiment of the present invention shown in FIG. 1 as a conceptual schematic, there is provided a coffee bean roaster 10 with recirculated, filtered exhaust airflow. The coffee bean roaster 10 includes a roasting drum 12 sized and configured to receive coffee beans 14 for roasting therein. The roasting drum 12 has a drum airflow inlet 16 and a drum airflow outlet 18 for exhausting airflow from the roasting drum 12. The coffee bean roaster 10 further includes a blower 20 configured to blow airflow through the drum airflow inlet 16 for venting the roasting drum 12. The coffee bean roaster 10 further includes a fluid filter system 50 having a filter airflow inlet 24 and a filter airflow outlet 26. The filter airflow inlet 24 is in fluid communication with the drum airflow outlet 18. The fluid filter 50 is configured to filter airflow from the roasting drum 12. The filter airflow outlet 26 is in fluid communication with the blower 20 for recirculating airflow into the roasting drum 12.

The coffee bean roaster 10 further includes a drum housing 28. The drum housing includes a funnel 30 which extends into the interior of the roasting drum 12 and is used for filling the roasting drum 12 with the coffee beans 14 ready to be roasted. The drum housing 28 further has a dispensing port 32 which extends from the roasting drum 12 for removal of roasted coffee beans 14 from the roasting drum 12, after roasting is completed. The roasting drum 12 is disposed within the drum housing 28. The roasting drum 12 in driven by a motor (not shown) to rotate for agitating the coffee beans 14 during the roasting process. In this regard, the rotation of the roasting drum 12 may be controlled through a control unit 34. An operator may manipulate the control unit 34 through a control panel 36.

The coffee bean roaster 10 may further include a heater 38 disposed proximate to, or within the roasting drum 12 for heating airflow within the roasting drum 12. The heater 38 is in electrical communication with the control unit 34 for regulating the temperature of the heater 38. In operation, the heater 38 is activated to roast the coffee beans 14 within the roasting drum 12. Other heating arrangements may be utilized, such as a more direct heating by the roasting drum 12 itself as only one further example.

As the roasting process is contemplated to result in smoke and various gases evolved from the coffee beans 14, the blower 20 is utilized to effectively vent the roasting drum 12. Moreover, chaff developed from the roasting coffee beans 14 are also vented. The blower 20 may be disposed within or attached to the drum housing 28, and is disposed in electrical communication with the control unit 34 for regulating the airflow output of the blower 20.

The roaster 10, as described above is described in U.S. Pat. No. 6,382,087 to Ilyama. It is now our purpose to describe a new and improved apparatus and method of chilling, more effectively filtering, and recycling the airflow handled by blower 20. It is noted that the present invention comprises the roaster and the below described filter system 50 as a combination, and also encompasses the filter system 50 by itself as a novel apparatus and invention claimed by the inventor herein.

The roasting process not only requires application of heat, but also requires specific cooling procedures. In this regard, the venting of the roasting drum 12 by the blower 20 facilitates such cooling. Further, the drum housing 28 may include an outer drum airflow inlet and an outer drum airflow outlet as described in the '087 reference, which are configured to receive and vent airflow away from the exterior of the blower 20 for cooling the blower 20. In this regard, the blower 20 blows airflow about the outer drum airflow inlet which exits via the outer drum airflow outlet of the drum housing 28. Advantageously, as further discussed below, recirculation of airflow from the filter system 50 further facilitates the cooling process as the filter system 50 cools the airflow passing though it.

The coffee bean roaster 10 may further include a chaff collector 44 sized and configured to remove chaff from the airflow. The chaff collector may be disposed in fluid communication with the roasting drum 12 and the filter airflow inlet 24 of the filter system 50. In particular, airflow from the drum airflow outlet 18 is configured to enter the chaff collector 44 while allowing the airflow to pass. This is further described in the '087 reference.

The filter system 50 includes a filter housing 60. The filter housing 22 may be attached to or integrated with the drum housing 28. Alternatively, the filter housing 60 may be detachable from the drum housing 28 or even located remote from the drum housing 28 while still being in operable communication therewith. Airflow enters the filter housing 60 via the filter airflow inlet 24.

Preferably, the filter system 50 is a water-based filter. Further, a fluid source 72 may be sized and configured to recirculate fluid within the filter system 50. In this regard, the fluid source 72 may take the form of a fluid pump 62. The fluid source 72 may be in electrical communication with the control unit 34 for controlling the activation of the fluid pump 62 for delivery of the fluid, preferably water.

The filter system 50 preferably has a plurality of screens 64, individually denoted as 64a-d as shown. The screens 64a-d may take the form of a wire mesh or steel wool. The fluid source 72 is sized and configured to distribute fluid across the screens 64a-d so as to maintain wetness on their surfaces. In the embodiment shown, the screens 64a-d are positioned between the filter airflow inlet 24 and the filter airflow outlet 26 for passage of airflow through the screens 64a-d from the filter airflow inlet 24 to the filter airflow outlet 26. Each of the screens 64a-d may have an upper end 66 and a lower end 68, and the fluid source 72 is sized and configured to dispense fluid from the upper ends 66, as a drip system, for distributing fluid throughout the screens 64a-d towards the lower ends 68. A distribution hose 70 may be provided in fluid communication with the fluid source 72 for distributing fluid to the screens 64a-d. The distribution hose 70 may further be disposed adjacent the secondary filter. Fluid source 72 supports a reservoir of the operating fluid as shown and a drain 78 is provided for drawing the fluid out of source 72. Also, a fluid filter 74 is provided for filtering the fluid continuously during operation. Further, fluid will be collected at the blower and is directed therefrom via hose 71 to the fluid source 72.

Above the screens 64a-d is mounted a chiller compartment 80 within which hose 70 connects to a heat exchanger 84 (a series of convolutions of a copper pipe). The heat exchanger may be any form of well known device such as those used in mechanical refrigeration, but in the present embodiment, the exchanger 84 is designed to use ice cubes 82 which are loaded into the chiller compartment 80 from above.

In operation, heated air exiting the drum housing 28 at exit 18 moves through a tube or hose into the filter system 50 at inlet 24. This heated air moves through filter housing 60, passing through screens 64a-d in sequence as shown. The screens 64 are set up as a labyrinth so that the heated air travels through enough wet, chilled steel wool to cause it to be chilled to a degree necessary for this process. In addition, any particulate carried by the heated air is entrained in the screens 64. The now chilled air moves out of the filter housing 60 via exit 26 and via a further tube or hose, enters blower 20. Since the chilled air entering blower 20 is saturated with moisture, it has a tendency to be dehumidified as it passes through blower 20 and, as stated, such moisture is led back to the fluid source 72 via hose 71. The chilled air enters the roaster 10 via entrance 16, passes through the hot beans 14 within the drum 12 and then repeats the air flow cycle.

The fluid is pumped by pump 62 from the reservoir in fluid source 72 via hose 70 to heat exchanger 84 which is chilled by ice cubes 82 so that the fluid becomes chilled. The fluid then passes into manifold 85 and therefrom into tubes 87 which pass through the air inlet passage leading to screen 64a. Tubes 87 terminate at the top end 66 of the screens 64a-d and therefore deposit the fluid into the screens 64. The fluid moves as droplets over the steel wool within the screens 64, coating them and chilling them. The fluid collects small particulate and washes it out of the airflow and the screens 64. The fluid collects at the bottom 68 of the screens in pools and slowly drips into the reservoir of the fluid source 72. Because the fluid, as it moves, seals both the tubes 87 and the small apertures 65 at the bottom of the screens 64, the air tends to flow past these potential sources of air leakage, moving along its own path of least resistance as described above. The fluid collected in source 72 has absorbed thermal energy as it moved through the screens 64 and therefore enters the heat exchanger 84 at an elevated temperature. The exchanger absorbs this heat and chills the fluid so that it moves through a closed cycle effectively.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

What is claimed is:

1. A coffee bean roaster having a recirculated, filtered exhaust airflow; the coffee bean roaster including a roasting drum sized and configured to receive coffee beans for roasting therein; the roasting drum providing a drum airflow inlet and a drum airflow outlet for exhausting airflow from the roasting drum; a blower configured to blow airflow through the drum airflow inlet for venting the roasting drum; a fluid filter system having a filter airflow inlet and a filter airflow outlet, the filter airflow inlet in fluid communication with the drum airflow outlet, the fluid filter configured to filter airflow from the roasting drum; the filter airflow outlet in fluid communication with the blower for recirculating airflow into the roasting drum; a drum housing including a funnel extending into the interior of the roasting drum for receiving coffee beans ready for roasting; the drum housing further providing a dispensing port which extends from the roasting drum for removal of roasted coffee beans from the roasting drum; the roasting drum disposed within the drum housing and driven by a motor to rotate for agitating the coffee beans during the roasting process; the roaster further comprising a filter housing providing a filter system having a fluid source sized and configured to recirculate fluid within the filter system.

2. The roaster of claim 1 further providing a control unit and a control panel.

3. The roaster of claim 1 further providing a heater disposed proximate the roasting drum for heating airflow within the roasting drum.

4. The roaster of claim 3 wherein the heater is in electrical communication with the control unit for regulating the temperature of the heater.

5. The roaster of claim 1 further wherein the fluid source has a fluid pump.

6. The roaster of claim 5 wherein the fluid source is in electrical communication with the control unit for controlling the activation of the fluid pump for delivery of the fluid.

7. The roaster of claim 1 wherein the filter system has a plurality of screens, and wherein the fluid source is sized and configured to distribute fluid across the screens so as to maintain wetness on their surfaces.

8. The roaster of claim 7 wherein the screens are positioned between the filter airflow inlet and the filter airflow outlet for passage of airflow through the screens from the filter airflow inlet to the filter airflow outlet.

9. The roaster of claim 8 wherein the screens have an upper end and a lower end, the fluid source sized and configured to dispense fluid from the upper ends, as a drip system, for distributing fluid throughout the screens toward the lower ends.

10. The roaster of claim 8 wherein a distribution hose is provided in fluid communication with the fluid source for distributing fluid to the screens.

11. The roaster of claim 10 wherein the distribution hose is disposed adjacent the secondary filter.

12. The roaster of claim 1 wherein the fluid source supports a reservoir of the operating fluid and a drain is provided for drawing the fluid out of source, and a fluid filter is positioned for filtering the fluid continuously during operation.

13. The roaster of claim 12 wherein the fluid is collected at the blower and is directed therefrom via the hose to the fluid source.

14. The roaster of claim 10 wherein a chiller compartment is positioned above the screens, the compartment interconnected with a heat exchanger.
